(19) United States
(12) Patent Application Publication
(10) Pub. No.: US 2005/0216506 A1
(43) Pub. Date: Sep. 29, 2005

(54) Versioning electronic learning objects using project objects

(76) Inventors: Wolfgang Theilmann, Karlsruhe (DE); Wolfgang Gerteis, Karlsruhe (DE)

Correspondence Address: FISH & RICHARDSON, P.C., PO BOX 1022, MINNEAPOLIS, MN, 55440-1022, US

(21) Appl. No.: 10/809,873

(22) Filed: Mar. 25, 2004

(51) Int. Cl. G06E 1/00

(52) U.S. Cl. 707/103 Y

(57) ABSTRACT

A method, performed by a processing device, for use in an electronic learning system that stores information as learning objects, includes designating a target learning object as a project object, and storing dependency data in the project object. The dependency data identifies at least a version of a first object that depends directly from the project object, and a version of a second object that depends indirectly from the project object.

### BACKGROUND

This patent application relates generally to an electronic learning system and, more particularly, to versioning learning objects in the electronic learning system.

Electronic learning systems provide users with the ability to access course content directly from their computers, without the need for intermediaries, such as teachers, tutors, and the like. Such systems have proven attractive for precisely this reason.

The uniform approach of many electronic learning systems, however, can be a hindrance to many users. In particular, electronic learning systems often lack the flexibility required to provide an individualized learning experience.

### SUMMARY

In general, in one aspect, the invention is directed to method, performed by a processing device, for use in an electronic learning system that stores information as learning objects. The method includes designating a target learning object as a project object, and storing dependency data in the project object. The dependency data identifies at least a version of a first object that depends directly from the project object, and a version of a second object that depends indirectly from the project object. This aspect may include one or more of the following features.

The version of the second object may depend from the version of the first object. Designating may include storing data in the project object that indicates that the target learning object is the project object. The target learning object may be a portal to other learning objects in the electronic learning system. The other learning objects may define a course offered via the electronic learning system. The target learning object may be a glossary of a course. The electronic learning system may include a master repository that stores globally-available learning objects and a local repository that stores locally-available learning objects, and the method may include identifying learning objects that depend from the project object, and moving the project object and learning objects that depend from the project object between the local repository and the master repository. The method may include copying the version of the first object from the master repository to the local repository without copying the project object to the local repository, and resolving dependencies associated with the version of the first object in accordance with a rule.

The version of the first object may depend on the second object, and resolving may include making the version of the first object depend on a most current version of the second object in the local repository. The electronic learning system may include a master repository that stores globally-available learning objects and a local repository that stores locally-available learning objects. The method may include copying the project object, the version of the first object, and the version of the second object from the master repository to the local repository, creating a second version of the first object, and updating the dependency data in the project object to reference the second version of the first object.

At least one of the first and second objects may store information about a dependent object. The information may include an identity of the dependent object. The method may include copying the version of the first object from the master repository to the local repository without copying the project object to the local repository, and resolving dependencies associated with the version of the first object in favor of current versions of objects on which the first object depends.

Other features and advantages will be apparent from the description, the drawings, and the claims.

### DESCRIPTION OF THE DRAWINGS

FIG. 1 is a content aggregation model in an electronic learning system.

FIG. 2 is an example of an ontology of knowledge types for electronic learning.

FIG. 3 is an example of a course graph for electronic learning.

FIG. 4 is an example of a sub-course graph for electronic learning.

FIG. 5 is an example of a learning unit graph for electronic learning.

FIG. 6 is a block diagram of an architecture for the electronic learning system.

FIG. 7 shows screen printouts of a repository explorer used with the electronic learning system.

FIG. 8 is a block diagram of learning objects that illustrates object versioning using a project object.

Like reference numerals in different figures indicate like elements.

### DETAILED DESCRIPTION

Course Content and Structure

The electronic learning system (“ELS”) described herein structures course material (i.e., content) so that the content is reusable and flexible. The content structure allows an author of a course to reuse existing content to create new or additional courses. In addition, the content structure provides flexible content delivery that may be adapted to the learning styles of different users, thereby providing an individualized learning experience.

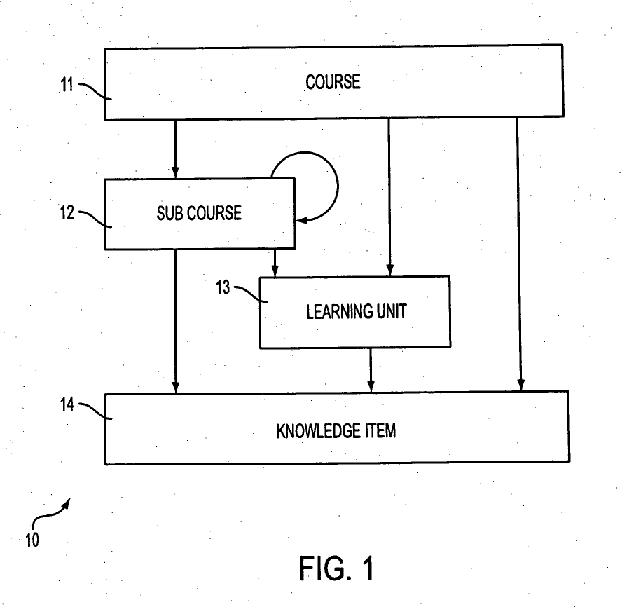

Electronic learning content in the ELS may be aggregated using a number of learning objects arranged at different aggregation levels. Each higher-level learning object may refer to any learning object at a lower level. At its lowest level, a learning object corresponds to content and is not further divisible. In one implementation of the ELS shown in FIG. 1, course material 10 may include four types of learning objects: a course 11, a sub-course 12, a learning unit 13, and a knowledge item 14.

Starting from the lowest level, knowledge items 14 are the basis for the other learning objects and are the building blocks of the course content structure. Each knowledge item 14 may include content that illustrates, explains, practices, or tests an aspect of a thematic area or topic. Knowledge items 14 typically are small in size (i.e., of short duration, e.g., approximately five minutes or less).

Attributes may be used to describe a knowledge item 14, examples of which include a name, a type of media, and a type of knowledge. The name may be used by the ELS to identify and locate the content associated with a knowledge item 14. The type of media describes the form of the content that is associated with the knowledge item 14. For example, media types include a presentation type, a communication type, and an interactive type. A presentation media type may include text, a table, an illustration, graphics, an image, animation, an audio clip, and/or a video clip. A communication media type may include a chat session, a group (e.g., a newsgroup, team, class, and group of peers), electronic mail, a short message service (SMS), and an instant message. An interactive media type may include a computer based training tool, a simulation, and a test.

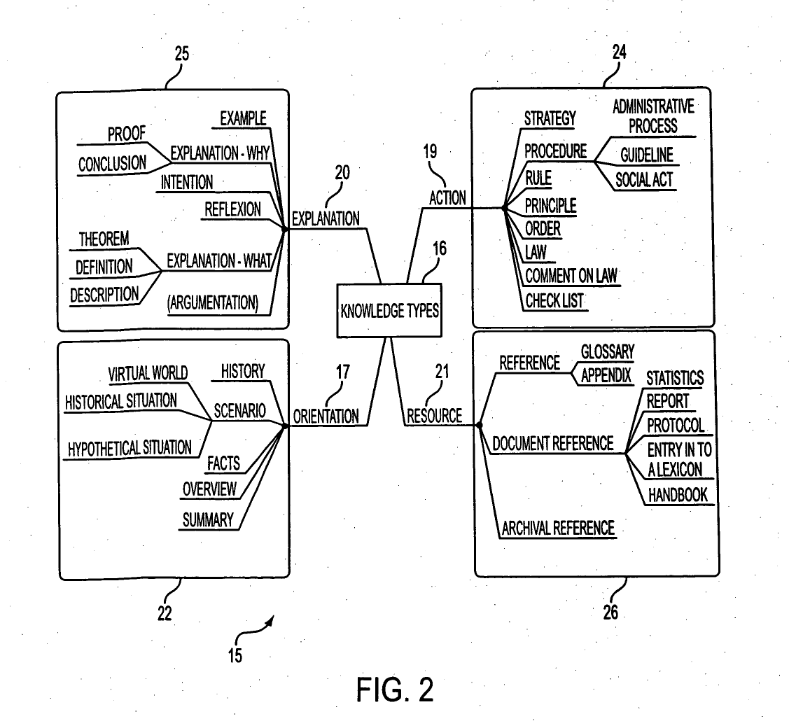

A knowledge item 14 also may be described by the attribute of knowledge type. For example, knowledge types include knowledge of orientation, knowledge of action, knowledge of explanation, and knowledge of source/reference (see FIG. 2). Knowledge types may differ in learning goal and content. For example, knowledge of orientation offers a point of reference to the user, and, therefore, provides general information for a better understanding of the structure of interrelated learning objects.

Knowledge items 14 may be generated using a wide range of technologies. In one implementation, a browser (including plug-in applications) interprets and displays appropriate file formats associated with each knowledge item. For example, markup languages, JavaScript (a client-side scripting language), and/or Flash may be used to create knowledge items 14. Examples of markup languages include, but are not limited to, Hypertext Markup language (HTML), standard generalized markup language (SGML), dynamic HTML (DHTML), and extensible markup language (XML).

HTML may be used to describe the logical elements and presentation of a document, such as, for example, text, headings, paragraphs, lists, tables, or image references. Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash permits pixel-precise positioning of graphical elements to generate interactive applications for presentation of course material to a user.

Learning units 13 may be assembled using one or more knowledge items 14 to represent, for example, a distinct, thematically-coherent unit. Consequently, learning units 13 may be considered containers for knowledge items 14 of the same general topic. Learning units 13 also may be relatively small in size (i.e., small in duration) though larger than a knowledge item 14.

Sub-courses 12 may be assembled using other sub-courses 12, learning units 13, and/or knowledge items 14. Sub-course 12 may be used to split up an extensive course into several smaller subordinate courses. Sub-courses 12 may be used to build an arbitrarily deep nested structure by referring to other sub-courses 12.

Courses may be assembled from all of the subordinate learning objects including sub-courses 12, learning units 13, and knowledge items 14. To foster maximum reuse, all learning objects may be self-contained and context free.

Learning objects may be tagged with metadata that is used to support adaptive delivery, reusability, and search/retrieval of content associated with the learning objects. For example, learning objective metadata (LOM) defined by the IEEE “Learning Object Metadata Working Group” may be attached to individual learning objects. A learning objective is information that is to be imparted by an electronic course, or a subset thereof, to a user taking the electronic course. The learning objective metadata noted above may represent numerical identifiers that correspond to learning objectives. The metadata may be used to configure an electronic course based on whether a user has met learning objectives associated with learning object(s) that make up the course.

Other metadata identifies the “version” of the object using an identifier, such as a number. Information identifying version dependencies is stored in primary learning objects, or “project objects”, which act as portals or gateways to other learning objects in the ELS. Object versions and their use are described in more detail below. Still other metadata may relate to a number of knowledge types (e.g., orientation, action, explanation, and resources) that may be used to categorize learning objects.

In this regard, as shown in FIG. 2, learning objects may be categorized using a didactical ontology 15 of knowledge types 16 that includes orientation knowledge 17, action knowledge 19, explanation knowledge 20, and resource knowledge 21. Orientation knowledge 17 helps a user to find the way through a topic without acting in a topic-specific manner and may be referred to as “know what”. Action knowledge 19 helps a user to acquire topic related skills and may be referred to as “know how”. Explanation knowledge 20 provides a user with an explanation of why something is the way it is and may be referred to as “know why”. Resource knowledge 21 teaches a user where to find additional information on a specific topic and may be referred to as “know where”.

The four knowledge types (orientation, action, explanation, and resource) may be further divided into a fine grained ontology as shown in FIG. 2. Orientation knowledge 17 may refer to sub-types 22 (of knowledge) that include a history, a scenario, a fact, an overview, and a summary. Action knowledge 19 may refer to sub-types 24 that include a strategy, a procedure, a rule, a principle, an order, a law, a comment on law, and a checklist. Explanation knowledge 20 may refer to sub-types 25 that include an example, an intention, a reflection, an explanation of why or what, and an argumentation. Resource knowledge 21 may refer to sub-types 26 that include a reference, a document reference, and an archival reference.

Dependencies (or “references”) between learning objects may be described by metadata in the learning objects. A relation may be used to describe a natural, subject-taxonomic relation between learning objects. A relation may be directional or non-directional. A directional relation may indicate that the relation between learning objects is true only in one direction. Directional relations should be followed. Relations may be divided into two categories: subject-taxonomic and non-subject taxonomic.

Subject-taxonomic relations may be divided into hierarchical relations and associative relations. Hierarchical relations may be used to express a relation between learning objects that have a relation of subordination or superordination. For example, a hierarchical relation between knowledge items A and B exists if B is part of A. Hierarchical relations may be divided into two categories: the part/whole relation (i.e., “has part”) and the abstraction relation (i.e., “generalizes”). For example, the part/whole relation “A has part B” describes that B is part of A. The abstraction relation “A generalizes B” implies that B is a specific type of A (e.g., an aircraft generalizes a jet or a jet is a specific type of aircraft).

Associative relations may be used to refer to a kind of relation of relevancy between two learning objects. Associative relations may help a user obtain a better understanding of facts associated with the learning objects. Associative relations describe a manifold relation between two learning objects and are mainly directional (i.e., the relation between learning objects is true only in one direction). Examples of associative relations, described below, include “determines”, “side-by-side”, “alternative to”, “opposite to”, “precedes”, “context of”, “process of”,” “values”, “means of”, and “affinity”.

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to”, “alternative to”, and “analogous to”. The “opposite to” relation implies that two learning objects are opposite in reference to at least one quality. The “precedes” relation describes a temporal relationship of succession (e.g., A occurs in time before B (and not that A is a prerequisite of B)). The “context of” relation describes the factual and situational relationship on a basis of which one of the related learning objects may be derived. An “affinity” between learning objects suggests that there is a close functional correlation between the learning objects (e.g., there is an affinity between books and the act of reading because reading is the main function of books).

Non Subject-Taxonomic relations may include the relations “prerequisite of” and “belongs to”. The “prerequisite of” and the “belongs to” relations do not refer to the subject-taxonomic interrelations of the knowledge to be imparted. Instead, these relations refer to progression of the course in the learning environment (e.g., as the user traverses the course). The “prerequisite of” relation is directional whereas the “belongs to” relation is non-directional. Both relations may be used for knowledge items 14 that cannot be further subdivided. For example, if the size of a screen is too small to display the entire content on one page, the page displaying the content may be split into two pages that are connected by the relation “prerequisite of”.

Another type of metadata defines competencies. Competencies may be assigned to learning objects, such as, for example, a sub-course 12 or a learning unit 13. Competencies may be used to indicate and evaluate the performance of a user as the user traverses the course material. A competency may be classified as a cognitive skill, an emotional skill, a sensory motor skill, or a social skill.

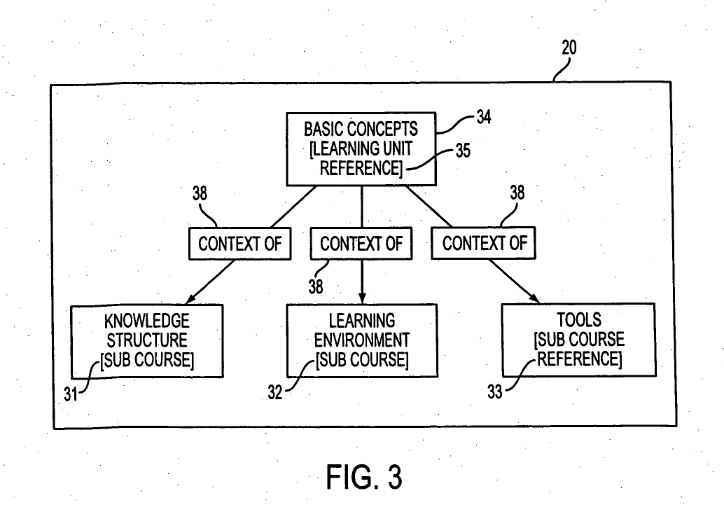

The content structure associated with a course may be represented as a set of graphs. A learning object may be represented as a node in a graph. Node attributes are used to convey the metadata attached to the corresponding learning object (e.g., a name, a knowledge type, a version number, a competency, and/or a media type). A relation between two learning objects may be represented as an edge. For example, FIG. 3 shows a graph 20 for a course. The course is divided into four learning objects or nodes (31, 32, 33, and 34): three sub-courses (e.g., knowledge structure, learning environment, and tools) and one learning unit (e.g., basic concepts).

A node attribute 35 of each node is shown in brackets (e.g., node 34 labeled “Basic concepts” has an attribute that identifies it as a reference to a learning unit). In addition, an edge 38 expressing the relation “context of” has been specified for the learning unit with respect to each of the sub-courses. As a result, the basic concepts explained in the learning unit provide the context for the concepts covered in the three sub-courses.

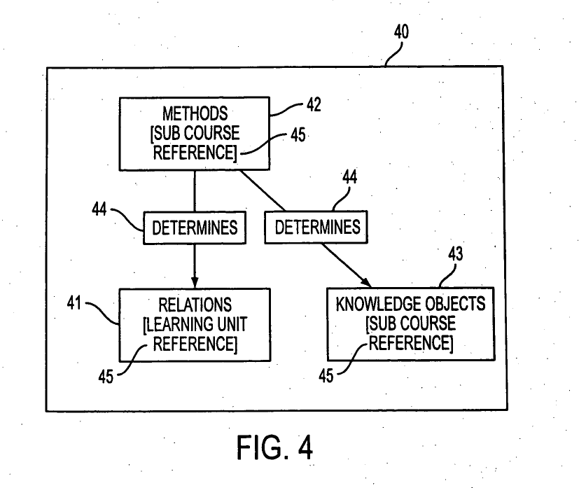

FIG. 4 shows a graph 40 of the sub-course “Knowledge structure” 31 of FIG. 3. In this example, the sub-course “Knowledge structure” is further divided into three nodes (41, 42, and 43): a learning unit (e.g., on relations) and two sub-courses (e.g., covering the topics of methods and knowledge objects). Edges 44 expressing the relation “determines” are provided between the learning objects (e.g., the sub-course “Methods” determines the sub-course “Knowledge objects” and the learning unit “Relations”). In addition, the attribute 45 of each node is shown in brackets (e.g., nodes “Methods” and “Knowledge objects” have the attribute identifying them as references to other sub-courses; node “Relations” has the attribute of being a reference to a learning unit).

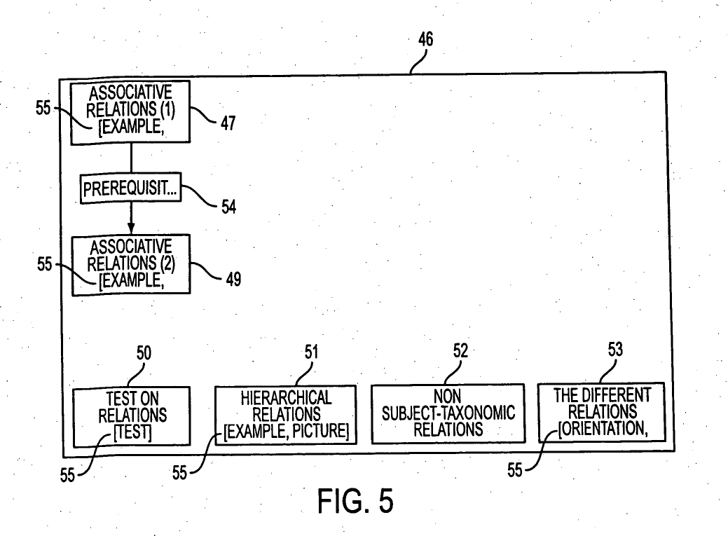

FIG. 5 shows a graph 46 for the learning unit “Relations” 41 shown in FIG. 4. The learning unit includes six nodes (47, 49, 50, 51, 52, and 53): six knowledge items (i.e., “Associative relations (1)”, “Associative relations (2)”, “Test on relations”, “Hierarchical relations”, “Non subject-taxonomic relations”, and “The different relations”). An edge 54 expressing the relation “prerequisite” has been provided between the knowledge items “Associative relations (1)” and “Associative relations (2).” In addition, attributes 55 of each node are specified in brackets (e.g., the node 51 “Hierarchical relations” includes the attributes “Example” and “Picture”).

Electronic Learning Strategies

The above-described content aggregation and structure associated with a course does not automatically enforce any sequence that a user may use to traverse content associated with the course. As a result, different sequencing rules may be applied to the same course structure to provide different paths through the course. The sequencing rules applied to the knowledge structure of a course constitute learning strategies. The learning strategies may be used to pick specific learning objects to be suggested to the user as the user progresses through the course. The user may select from a number of different learning strategies while taking a course. In turn, the selected learning strategy considers both the requirements of the course structure and the preferences of the user.

In a traditional classroom, a teacher determines the learning strategy that is used to learn course material. For example, in this context the learning progression may start with a course orientation, followed by an explanation (with examples), an action, and practice. Using the ELS, a user may choose between one or more learning strategies to determine which path to take through an electronic course. As a result, progressions of different users through the course may differ.

Course Configuration

The structure of a course is made up of graphs of the learning objects. A navigation tree may be determined from the graphs by applying a selected learning strategy to the graphs. The navigation tree may be used to navigate a path through the course for the user. Only parts of the navigation tree may be displayed to the user at the learning portal based on the position of the user within the course.

Learning strategies are applied to static course structure including learning objects (nodes), metadata (attributes), and relations (edges). This data is created when the course structure is determined (e.g., by a course author). Once the course structure is created, the course player processes the course structure using a strategy to present the material to the user at the learning portal. The course may be custom-tailored to a user's needs either before or during presentation of the materials.

Architecture

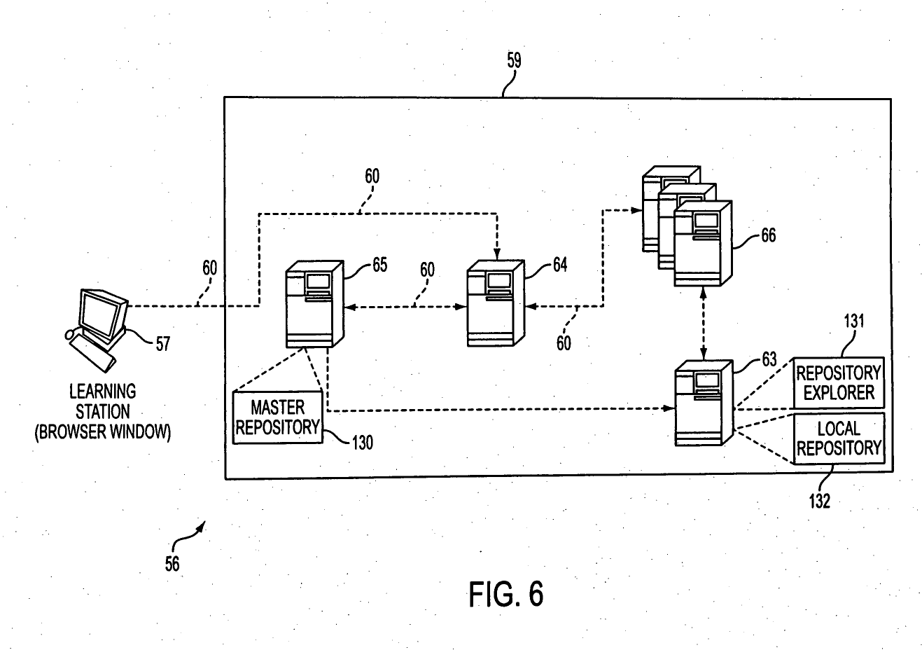

As shown in FIG. 6 an architecture 56 on which the ELS may be implemented may include a learning station 57 and a learning system 59. A user may access course material using learning station 57 (e.g., via a browser). Learning station 57 may be implemented using a work station, a computer, a portable computing device, or any intelligent device capable of executing instructions and connecting to a network.

Learning station 57 may include any number of devices and/or peripherals (e.g., displays, memory/storage devices, input devices, interfaces, printers, communication cards, and speakers) that facilitate access to, and use of, course material.

Learning station 57 may execute any number of software applications, including applications that are configured to access, interpret, and present courses and related information to a user. The software may be implemented using a browser, such as, for example, NETSCAPE® COMMUNICATOR®, MICROSOFT® INTERNET EXPLORER®, or any other software application that may be used to interpret and process a markup language, such as HTML, SGML, DHTML, or XML. The browser also may include one or more software plug-in applications that allow the browser to interpret, process, and present different types of information. The browser may include any number of application tools, such as, for example, JAVA®, Active X, JavaScript, and Flash.

The browser may be used to access a learning portal that allows a user to access the learning system 59. Links 60 between learning station 57 and learning system 59, and among various elements of learning system 59 may be configured to send and to receive signals (e.g., electrical, electromagnetic, or optical). In addition, the links may be wireless links that use electromagnetic signals (e.g., radio, infrared, to microwave) to convey information between the learning station and the learning system.

The ELS may include one or more servers. As shown in FIG. 6, the learning system 59 includes a learning management system 64, an authoring station 63, a content management system 65, and an administration management system 66.

Authoring station 63 may be a computer or other general-purpose processing device that has access to content management system 65 and administration management system 66. A memory on authoring station 63 includes a local repository. The local repository stores read-only and/or edited versions of learning objects. Use of the local repository in the ELS is described below. Any number of authoring stations may exist in the ELS.

The administration system 66 may be implemented using a server, such as, for example, the SAP® R/3 4.6C+LSO Add-On. The administration system may include a database of user accounts and course information. For example, a user account may include a profile containing demographic data about the user (e.g., a name, an age, a sex, an address, a company, a school, an account number, and a bill) and his/her progress through the course material (e.g., places visited, tests completed, skills gained, knowledge acquired, and competency using the material). The administration system also may provide additional information about courses, such as the courses offered, the author/instructor of a course, and the most popular courses.

The content management system 65 may include a learning content server. The learning content server may be implemented using a WebDAV server. The learning content server may include a master content repository 130. The master content repository, also referred to herein as the “master repository”, stores the learning objects described above, which are used to present a course to a user at learning station 57. The master repository stores objects that are valid throughout the entire ELS (i.e., “globally-valid” objects). More specifically, although different versions of objects may be stored in various local repositories, e.g., 132, only the objects stored in the master repository may be accessed by any user of the ELS. As such, an author at an authoring station must “check-in” a local version of a learning object into the master repository before that local version can be used by others in the ELS. This feature is described in more detail below.

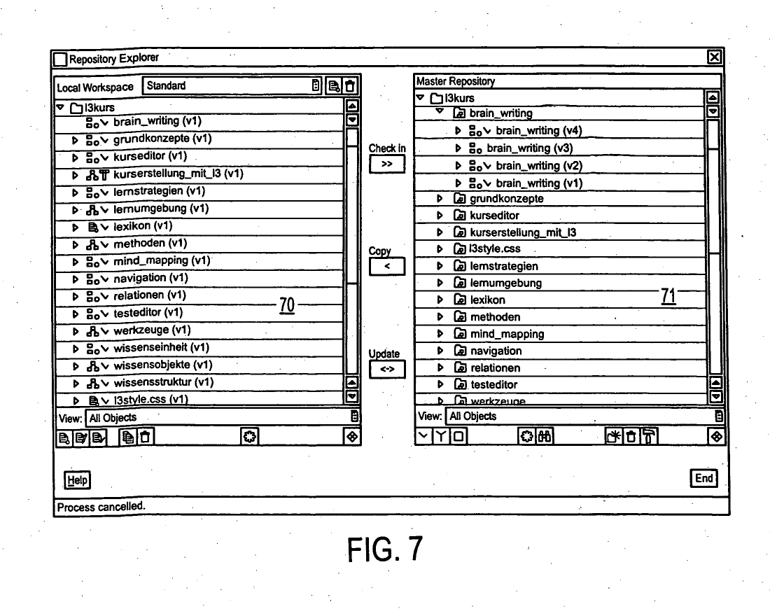

The master and local repositories may be managed via a computer program known as the repository explorer 131. The repository explorer may be run on authoring station 63, and may communicate with both a local repository and the master repository. Appropriate network connections may be used to effect communication. As shown in FIG. 7, the repository explorer includes a window 70 that displays a list of objects stored in the local repository, and window 71 that displays a list of objects stored in the master repository.

The learning management system 64 may also include a content player. The content player may be implemented using software running on a server, such as, an SAP® J2EE Engine. The content player obtains course material (i.e., learning objects) from the master repository and presents content from those objects to a user. The content player also applies learning strategies to the obtained course material to generate a navigation tree for the user. The navigation tree is used to suggest a route through the course material for the user and to generate a presentation of course material to the user based on the learning strategy selected by the user. The learning management system 64 also may include an interface for exchanging information with the administration system 66. For example, the content player may update user account information as the user progresses through the course material via the interface to the administration system.

Versioning Learning Objects

In the ELS, existing learning objects may be revised and/or combined to create new versions of existing objects. What is meant by a “version”, in this context, is a learning object that is derived from, or based on, another learning object. The process of creating new versions of existing learning objects is called “versioning”.

Versioning of data objects is used in many technologies, including software development, document management systems, and Web site management. There are differences, however, between versioning systems used in other applications and the versioning used in the ELS. In general, versioning systems used in traditional applications have only one currently valid configuration. That is, such applications have a single version of each object for use in the application. By contrast, in the ELS, different versions of the same object can be used at the same time.

In this implementation, the ELS supports two types of learning objects: compound objects (comprised of a set of files or documents) and atomic objects (containing only a single file or document). Object versions are stored in a local repository without any specific version information encoded in the local object location. Thus, within a local repository, the ELS can store at most one version of a specific object at one point in time.

Object versions in the master repository cannot be changed (except by a system administrator). ELS content authors work in their local repositories, to which they can copy objects from the master repository (as read-only objects), and in which they can create and edit new object versions. Objects created in local repositories can be copied and stored back in the master repository. Storing objects from the local repository into the master repository is known as “checking-in”, and is described below. The ELS also allows authors to “use” objects (via references) without storing the objects in their local repositories.

So long as an author does not need to move object versions to and/or from the master repository, the author can work in a local repository without being connected to the master repository. This work model is termed the “offline scenario”. Working in the local repository, while being connected to the master repository, is termed the “online scenario”.

The ELS thus supports the following operations: storing (i.e., checking-in) object versions edited or created in a local repository into the master repository (thus turning them into persistent, immutable objects), copying object versions from the master repository to a local repository (as read-only objects), editing read-only objects in a local repository to create new editable object versions, and deleting objects from the local repository.

Learning objects may depend on each other, since their files may contain cross-references. An object A directly references (i.e., depends on) an object B if any file within object A contains a reference to any file within object B. In the context of a project object, object version A indirectly references object version C if any object version referenced by object version A references directly or indirectly object version C.

References (i.e., dependencies) between learning objects are managed and stored by the ELS. Dependency information is included in each version of each object. However, each object does not contain version information about the target object (i.e., the dependent object). Each object simply specifies the dependent object without its corresponding version. The project object specifies the version information.

As noted above, a project object stores data identifying dependencies among versions of learning objects. A project object is typically, though not necessarily, a learning object that acts as a portal (or gateway) to other learning objects for which the project object defines version dependencies. What this means is that a user accesses the other learning objects through the project object. Any of the learning objects described herein may act as a project object. Examples of a project object include, but are not limited to, an entry object of a course and a glossary object. In the case of a course, the project object specifies the versions of all directly or indirectly dependent objects that can be accessed by navigating through the course. In the case of a glossary, which may be intended for use by one or more courses, the project object again specifies the versions of all dependent objects. This specification serves as recommendation about object versions to be used when the glossary is included into a larger course. Other objects may also act as portals.

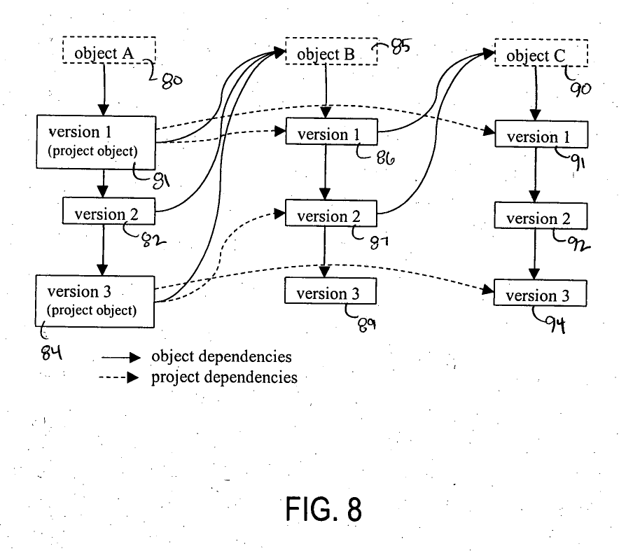

A project object may be designated by the author of an electronic course. For example, the author may store data in a target object indicating that the target object is a project object. Project object definitions may change as an author incorporates new learning objects, or object versions, into an electronic course. For example, during the authoring process, an author may designate a different object to be the project object. Selected versions of an object may be designated as the project object. For example, as shown in FIG. 8, versions “1” and “3” of object “A” have been designated as the project object, but not version “2” of object “A”.

The dependencies of learning objects are defined by metadata in each learning object version, as described above. The version dependencies, however, are not defined in each learning object, but rather only by metadata in the project object. FIG. 8 illustrates this distinction. As shown in FIG. 8, in a local repository, object “A” 80 may exist in three versions “1” 81, “2” 82, and “3” 84; object “B” 85 may exist in three versions “1” 86, “2” 87, and “3” 88; and object “C” 90 may exist in three versions “1” 91, “2” 92, and “3” 94. As shown by the solid arrows, versions “1” to “3” of object “A” depend on object “B”, and versions “1” and “2” of object “B” depend on object “C”. This dependency information, which is stored in the metadata of each learning object version, does not reflect the versions of the dependent objects, only their identities. So, for example, the metadata of object “B” version “1” indicates a dependency on object “C”, but does not identify the version of object “C” on which version “1” of object “B” depends. Similarly, object “B” version “2” indicates a dependency on object “C”, but does not identify the version of object “C” on which version “2” of object “B” depends.

The project object, however, contains metadata identifying versions of objects that depend, either directly or indirectly, from a version of the project object. The dotted arrows shown in FIG. 8 represent these version dependencies. For example, as illustrated by the dotted arrows, version “1” of object “A” depends on version “1” of object “B”, and on version “1” of object “C”. Similarly, version “3” of object “A” depends on version “2” of object “B” and on version “3” of object “C”. It is noted that version “2” of object “A” does not show any version dependencies. This is because version “2” of object “A” has not been designated as a project object.

The metadata that defines the version dependencies of the project object also implicitly defines the dependencies of object versions referenced by the project object. Thus, the metadata that defines the version dependencies of object “A” also implicitly defines version dependencies between objects “B” and “C”. For example, since object “B” version “1” depends on object “C”, and since object “A” version “1” depends directly on object “B” version “1” and indirectly on object “C” version “1”, it follows that object “B” version “1” depends on object “C” version “1” (at least within the context of object “A” version “1”).

A project object and its dependent object(s) may be copied from the master repository to a local repository, and may be checked-in from the local repository to the master repository. If a version of an object is copied, e.g., from the master repository to a local repository, without the context of a project object, the ELS may resolve object dependencies according to one or more predefined rules. Resolving object dependencies is necessary in this instance because, as noted, non-project objects do not contain version dependency data. As such, copying an object to the local repository, without the context of a project object, leaves the copied object without any information regarding objects it references (i.e., versions of objects on which the copied object depends). Software within the ELS (running, e.g., in the local repository or master repository) resolves unknown dependencies associated with copied objects.

In one embodiment, the ELS resolves the dependencies by making the copied object depend on the latest version of each object that it references. That is, as noted above, each non-project object retains, within its metadata, the identities (but not versions) of all objects on which it depends. The ELS may thus resolve the dependencies of the copied object so that the copied object references the latest version of each object on which it depends. The ELS may identify the latest version of each object by examining the metadata of all versions of an object in, e.g., the master repository. The version with the highest “version number”, which may be defined in that object's metadata, may be used. Alternatively, the metadata may contain a timestamp indicating the time at which the version was created. The ELS may use any means or method of identifying the latest version.

In another embodiment, the ELS resolves dependencies by checking and comparing specific properties of object versions. For example, the ELS might check the object versions' status for filtering purposes. If a version of an object is copied, e.g., from the master repository to a local repository, within the context of a project object, the ELS may resolve object dependencies either according to the specifications made by the project object or according to one of the predefined rules described above.

When object versions from a local repository are checked into a master repository a dependency resolution need not be performed. Object versions can be checked-in as is. In addition, the check-in process is independent of the project object.

Thus, in the authoring environment, an author can copy and revise versioned learning objects, and thereby maintain different versions of the same learning object, without many of the complications associated with versioning. For example, the ELS permits identifying learning objects that depend from a project object, and moving the project object and learning objects that depend from the project object between the local repository and the master repository. The ELS also allows authors to create new object versions and to update metadata in the project object to reference those new versions. For example, an author may copy a project object from the master repository to a local repository, along with versions of first and second objects that depend from the project object. The author may then create a different version of, e.g., the first object and update the dependency data in the project object to reference that different version. The same may also be done for the second object. Once the new object versions are created, and the project object is updated accordingly, all may be checked-in to the master repository, from which the objects can be accessed by others using the ELS.

Other Implementations

The ELS is not limited to use with the hardware and software described herein; it may find applicability in any computing or processing environment and with any type of machine that is capable of running machine-readable instructions, such as a computer program.

The ELS can be implemented in digital electronic circuitry, or in computer hardware, firmware, software, or in combinations of them. The ELS can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the ELS can be performed by one or more programmable processors executing a computer program to perform functions of the ELS by operating on input data and generating output. Method steps can also be performed by, and the ELS can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The ELS can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the record extractor, or any combination of such back-end, middleware, or front-end components. The components of the system can be interconnected by any form or medium of digital data communication, e.g., a communication network. Examples of communication networks include a local area network (“LAN”) and a wide area network (WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The processes described above are not limited to the implementations set forth herein. For example, the processes are not limited to use with the ELS described herein, but rather may be implemented in any type of computer-based training system. The processes can be applied to any computer based information system in which information objects, elements, etc. are to be versioned and in which cross-references between different entities are maintained.

The processes described above may also be implemented in any kind of hypermedia system that allows for authoring and managing hypermedia content consisting of content objects and references/dependencies between them.

Other implementations are also within the scope of the following claims.

1. A method, performed by a processing device, for use in an electronic learning system that stores information as learning objects, the method comprising:
designating a target learning object as a project object;
storing dependency data in the project object, the dependency data identifying at least a version of a first object that depends directly from the project object, and a version of a second object that depends indirectly from the project object.

2. The method of claim 1, wherein the version of the second object depends from the version of the first object.

3. The method of claim 1, wherein designating comprises storing data in the project object that indicates that the target learning object is the project object.

4. The method of claim 1, wherein the target learning object comprises a portal to other learning objects in the electronic learning system.

5. The method of claim 1, wherein the other learning objects define a course offered via the electronic learning system.

6. The method of claim 4, wherein the target learning object comprises a glossary of a course.

7. The method of claim 1, wherein the electronic learning system comprises a master repository that stores globally-available learning objects and a local repository that stores locally-available learning objects, and the method further comprises:
identifying learning objects that depend from the project object;
moving the project object and learning objects that depend from the project object between the local repository and the master repository.

8. The method of claim 1, wherein the electronic learning system comprises a master repository that stores globally-available learning objects and a local repository that stores locally-available learning objects, and the method further comprises:
copying the version of the first object from the master repository to the local repository without copying the project object to the local repository; and
resolving dependencies associated with the version of the first object in accordance with a predefined rule.

9. The method of claim 8, wherein the version of the first object depends on the second object, and resolving comprises making the version of the first object depend on a most current version of the second object in the local repository.

10. The method of claim 1, wherein the electronic learning system comprises a master repository that stores globally-available learning objects and a local repository that stores locally-available learning objects, and the method further comprises:
copying the project object, the version of the first object, and the version of the second object from the master repository to the local repository;
creating a second version of the first object; and
updating the dependency data in the project object to reference the second version of the first object.

11. The method of claim 1, wherein at least one of the first and second objects stores information about a dependent object.

12. The method of claim 11, wherein the information comprises an identity of the dependent object.

13. The method of claim 1, wherein the electronic learning system comprises a master repository that stores globally-available learning objects and a local repository that stores locally-available learning objects, and the method further comprises:
copying the version of the first object from the master repository to the local repository without copying the project object to the local repository; and
resolving dependencies associated with the version of the first object in favor of current versions of objects on which the first object depends.

14. A computer program product for use in an electronic learning system that stores information as learning objects, the computer program product being tangibly embodied in an information carrier, the computer program product being operable to cause a machine to:
designate a target learning object as a project object;
store dependency data in the project object, the dependency data identifying at least a version of a first object that depends directly from the project object, and a version of a second object that depends indirectly from the project object.

15. The computer program product of claim 14, wherein the version of the second object depends from the version of the first object.

16. The computer program product of claim 14, wherein designating comprises storing data in the project object that indicates that the target learning object is the project object.

17. The computer program product of claim 14, wherein the target learning object comprises a portal to other learning objects in the electronic learning system.

18. The computer program product of claim 14, wherein the other learning objects define a course offered via the electronic learning system.

19. The computer program product of claim 7, wherein the target learning object comprises a glossary of a course.

20. The computer program product of claim 14, wherein the electronic learning system comprises a master repository that stores globally-available learning objects and a local repository that stores locally-available learning objects, and the computer program product further comprises instructions operable to cause the machine to:
identify learning objects that depend from the project object;
move the project object and learning objects that depend from the project object between the local repository and the master repository.

21. The computer program product of claim 14, wherein the electronic learning system comprises a master repository that stores globally-available learning objects and a local repository that stores locally-available learning objects, and the computer program product further comprises instructions operable to cause the machine to:
copy the version of the first object from the master repository to the local repository without copying the project object to the local repository; and
resolve dependencies associated with the version of the first object in accordance with a predefined rule.

22. The computer program product of claim 14, wherein the version of the first object depends on the second object, and resolving comprises making the version of the first object depend on a most current version of the second object in the local repository.

23. The computer program product of claim 14, wherein the electronic learning system comprises a master repository that stores globally-available learning objects and a local repository that stores locally-available learning objects, and the computer program product further comprises instructions operable to cause the machine to:
copy the project object, the version of the first object, and the version of the second object from the master repository to the local repository;
create a second version of the first object; and
update the dependency data in the project object to reference the second version of the first object.

24. The computer program product of claim 14, wherein at least one of the first and second objects stores information about a dependent object.

25. The computer program product of claim 14, wherein the information comprises an identity of the dependent object.

26. The computer program product of claim 14, wherein the electronic learning system comprises a master repository that stores globally-available learning objects and a local repository that stores locally-available learning objects, and the computer program product further comprises instructions to:
copy the version of the first object from the master repository to the local repository without copying the project object to the local repository; and
resolve dependencies associated with the version of the first object in favor of current versions of objects on which the first object depends.
